(19) United States
(12) Patent Application Publication
(10) Pub. No.: US 2024/0030500 A1
(43) Pub. Date: Jan. 25, 2024

(54) SLOW-RELEASE ADDITIVE FOR ABUSE TOLERANT LITHIUM-ION BATTERY CELL

(71) Applicant: FORD GLOBAL TECHNOLOGIES, LLC, Dearborn, MI (US)

(72) Inventors: Andrew TIPTON, Dearborn, MI (US); Brett Stanley HINDS, Clarkston, MI (US); Chi PAIK, Grosse Ile, MI (US)

(21) Appl. No.: 17/871,072

(22) Filed: Jul. 22, 2022

(51) Int. Cl. H01M 10/42; H01M 10/0525; H01M 4/04; H01M 50/46

(52) U.S. Cl. CPC H01M 10/4235; H01M 10/0525; H01M 4/0404; H01M 50/46; H01M 2004/028

(57) ABSTRACT

A thermal runaway inhibiting composition for a battery includes a plurality of particles. Each particle includes an encapsulant configured to melt at a temperature greater than 70° C. and a flame retardant additive encapsulated by the encapsulant. Characteristically, the plurality of particles having a size distribution to inhibit thermal runaway when the thermal runaway-inhibiting composition is included in a battery cell.

### TECHNICAL FIELD

In at least one aspect, a slow-release additive for lithium-ion batteries is provided.

### BACKGROUND

Electrolyte additives, such as phosphates, are available in electrolytic solutions to offer improved thermal runaway resistance in a lithium-ion battery (LIB). The additives introduce barriers to obstruct electrochemical kinetics and mass transport. These additives may, however, have side effects, such as poor cell performance and low power. These low flammability electrolyte additives may also increase cell resistance. A non-invasive solution is needed to offer an electrolyte that is both non-flammability and high performance.

Accordingly, a non-invasive solution is needed to offer both non-flammability and high performance.

### SUMMARY

In at least one aspect, a thermal runaway-inhibiting composition for a battery is provided. The thermal runaway-inhibiting composition includes a plurality of particles. Each particle includes an encapsulant configured to melt at a temperature greater than 70° C. and a flame retardant additive encapsulated by the encapsulant. Advantageously, the plurality of particles has a size distribution that allows inhibits of thermal runaway when the thermal runaway-inhibiting composition is included in a battery cell.

In another aspect, a non-invasive, slow-releasing component can be introduced into a LIB system via an electrolytic solution or electrode. For example, a wax encapsulated flame retardant additive can be introduced in the electrolytic solution and/or in the ceramic layer bed to activate upon high temperature (e.g., >100° C.). These encapsulated additive agents do not interfere with the original battery function. But at the very beginning stage of an exothermic situation, the encapsulant can melt or dissolve and release a quick passivating agent that can stifle further thermal reaction or oxygen release.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1. Schematic cross-section of an encapsulated particle used in a thermal runaway-inhibiting composition for a lithium-ion battery.

FIG. 2A. Schematic cross-section of an electrode having an electrode active material having the composition of FIG. 1 and coated on one side of a current collector.

FIG. 2B. Schematic cross-section of an electrode having an electrode active material having the composition of FIG. 1 and coated on both sides of a current collector.

FIG. 3. Schematic cross-section of a battery cell incorporating the electrode of FIG. 2A.

FIG. 4. Schematic cross-section of a battery incorporating the battery cell of FIG. 3.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

The term “microcrystalline wax” means a kind of wax that is a refined mixture of solid, saturated aliphatic hydrocarbons, and produced by de-oiling certain fractions from the petroleum refining process. Microcrystalline waxes differ from refined paraffin wax in that the molecular structure is more branched and the hydrocarbon chains are longer (higher molecular weight). The crystal structure of microcrystalline wax is much finer than paraffin wax. In particular, the crystal size of the microcrystalline wax is smaller and the molecular weight larger compared with paraffin wax. In a refinement, the microcrystalline wax has a weight-average molecular weight of 500 to 800 and a melting point of 60 to 90° C.

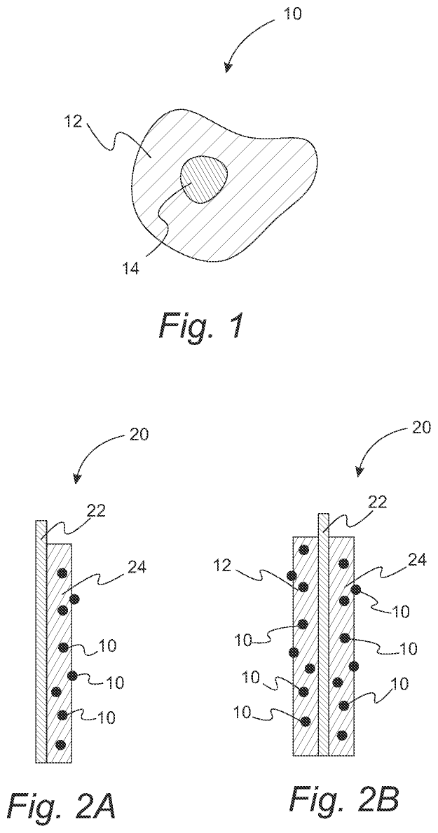

Referring to FIG. 1, a schematic of a representative particle of a thermal runaway-inhibiting composition for a battery. The thermal runaway-inhibiting composition includes a plurality of particles 10. Each particle 10 includes an encapsulant 12 (e.g., solid organic shell) configured to melt at a temperature greater than 70° C. Flame retardant additive 14 is encapsulated by the encapsulant 12, the flame retardant additive being present in a sufficient amount to inhibit thermal runaway in a battery when the composition is included therein. Examples of flame retardant additives include but are not limited to trimethyl phosphate (TMP), triphenyl phosphate (TPP), triallyl phosphates, and combinations thereof.

In a variation, the encapsulant 12 has a melting point from about 70° C. to about 120° C. In some variations, the encapsulant 12 has a melting point greater than or equal to in increasing order of preference, 70° C., 75° C., 80° C., 85° C., or 90° C. and less than or equal to in increasing order of preference 130° C., 125° C., 120° C., 115° C., or 110° C.

Typically the encapsulant 12 is composed of wax, and in particular, a microcrystalline wax. In a refinement, the plurality of particles have an average particle size from about 1 to 50 microns.

With references to FIGS. 2A and 2B, an electrode for a lithium-ion battery having flame-resistant properties using the composition of FIG. 1 is provided. Electrode 20 includes a current collector 22 and an electrochemically active layer 24 disposed over the current collector. FIG. 2A depicts a variation in which a single side of the current collector is coated while FIG. 2B depicts a variation in which both sides are coated. A thermal runaway-inhibiting composition is dispersed in and/or coating the electrochemically active layer 24. The thermal runaway-inhibiting composition includes a plurality of particles 10. Each particle 10 includes an encapsulant configured to melt at a temperature greater than 70° C. and a flame retardant additive encapsulated by the encapsulant as set forth above. Advantageously, the plurality of particles has a size distribution to inhibit thermal runaway when the thermal runaway-inhibiting composition is included in a battery cell.

In a variation, electrode 20 includes the thermal runaway-inhibiting composition in an amount of 5 to 25 percent of the combined weight of the electrically active layer 24 and the thermal runaway-inhibiting composition. In some variations, electrode 20 includes the thermal runaway-inhibiting composition in an amount of at least in increasing order of preference 3 wt %, 5 wt %, 7 wt %, 10 wt %, 12 wt %, or 15 wt % of the combined weight of the electrically active layer 24 and the thermal runaway-inhibiting composition. In a refinement, electrode 20 includes the thermal runaway-inhibiting composition in an amount of at most in increasing order of preference 50 wt %, 40 wt %, 35 wt %, 30 wt %, 25 wt %, or 20 wt % of the combined weight of the electrically active layer 24 and the thermal runaway-inhibiting composition.

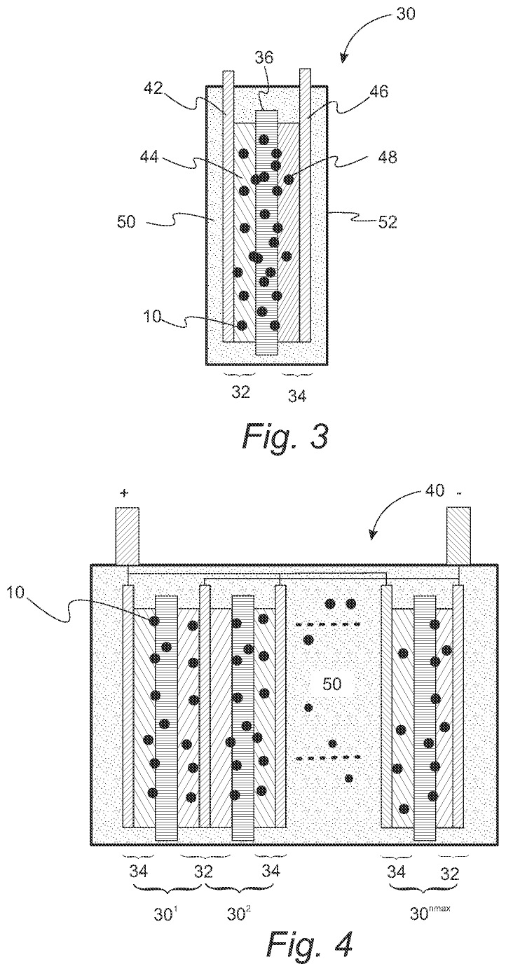

With reference to FIG. 3, a schematic of a rechargeable lithium-ion battery cell incorporating the positive electrode of FIG. 1 is provided. Battery cell 30 includes positive electrode 32, negative electrode 34, and separator 36 interposed between the positive electrode and the negative electrode. Positive electrode 32 includes a positive electrode current collector 42 and positive electrode active material 44 disposed over the positive electrode current collector. Typically, positive electrode current collector 42 is a metal plate or metal foil composed of a metal such as aluminum, copper, platinum, zinc, titanium, and the like. Currently, aluminum is most commonly used for the negative electrode current collector. Similarly, negative electrode 34 includes a negative electrode current collector 46 and a negative active material layer 48 disposed over and typically contacting the negative current collector. Typically, negative electrode current collector 46 is a metal plate or metal foil composed of a metal such as aluminum, copper, platinum, zinc, titanium, and the like. Currently, copper is most commonly used for the negative electrode current collector. The battery cell is immersed in electrolyte 50 which is enclosed by battery cell case 52. Electrolyte 50 imbibes into separator 36. In other words, the separator 36 includes the electrolyte thereby allowing lithium ions to move between the negative and positive electrodes. The electrolyte includes a non-aqueous organic solvent and a lithium salt. The non-aqueous organic solvent serves as a medium for transmitting ions taking part in the electrochemical reaction of a battery.

In a variation, electrode 20 includes the thermal runaway-inhibiting composition in an amount of 5 to 25 percent of the combined weight of the electrolyte 50 and the thermal runaway-inhibiting composition. In some variations, electrode 20 includes the thermal runaway-inhibiting composition in an amount of at least in increasing order of preference 3 wt %, 5 wt %, 7 wt %, 10 wt %, 12 wt %, or 15 wt % of the combined weight of the electrolyte 50 and the thermal runaway-inhibiting composition. In a refinement, electrode 20 includes the thermal runaway-inhibiting composition in an amount of at most in increasing order of preference 50 wt %, 40 wt %, 35 wt %, 30 wt %, 25 wt %, or 20 wt % of the combined weight of the electrolyte 50 and the thermal runaway-inhibiting composition.

With reference to FIG. 4, a schematic of a rechargeable lithium-ion battery incorporating the positive electrode of FIG. 1 and the battery cells of FIG. 2 is provided. Rechargeable lithium-ion battery 40 includes at least one battery cell of the design in FIG. 2. Typically, rechargeable lithium-ion battery 40 includes a plurality of battery cells 30ⁱ of the design of FIG. 2 where i is an integer label for each battery cell. The label i runs from 1 to nmax, where nmax is the total number of battery cells in rechargeable lithium-ion battery 40. Each lithium-ion battery cell 30ⁱ includes a positive electrode 32 which includes a positive electrode active material, a negative electrode 34 which includes a negative active material, and an electrolyte 50, The electrolyte includes a non-aqueous organic solvent and a lithium salt. The non-aqueous organic solvent serves as a medium for transmitting ions taking part in the electrochemical reaction of a battery. The plurality of battery cells can be wired in series, in parallel, or a combination thereof. The voltage output from battery 40 is provided across terminals 42 and 44.

Referring to FIGS. 3 and 4, separator 36 physically separates the negative electrode 34 from the positive electrode 32 thereby preventing shorting while allowing the transport of lithium ions for charging and discharging. Therefore, separator 36 can be composed of any material suitable for this purpose. Examples of suitable materials from which separator 36 can be composed include but are not limited to, polytetrafluoroethylene (e.g., TEFLON®), glass fiber, polyester, polyethylene, polypropylene, and combinations thereof. Separator 36 can be in the form of either a woven or non-woven fabric. Separator 36 can be in the form of a non-woven fabric or a woven fabric. For example, a polyolefin-based polymer separator such as polyethylene and/or polypropylene is typically used for a lithium-ion battery. In order to ensure heat resistance or mechanical strength, a coated separator includes a coating of ceramic or a polymer material may be used.

Referring to FIGS. 3 and 4, electrolyte 50 includes a lithium salt dissolved in the non-aqueous organic solvent. Therefore, electrolyte 50 includes lithium ions that can intercalate into the positive electrode active material during charging and into the anode active material during discharging. Examples of lithium salts include but are not limited to LiPF₆, LiBF₄, LiSbF₆, LiAsF₆, LiC₄F₉SO₃, LiClO₄, LiAlO₂, LiAlCl₄, LiCl, LiI, LiB(C₂O4)₂, and combinations thereof. In a refinement, the electrolyte includes the lithium salt in an amount from about 0.1 M to about 2.0 M.

Still referring to FIGS. 3 and 4, the electrolyte includes a non-aqueous organic solvent and a lithium salt. Advantageously, the non-aqueous organic solvent serves as a medium for transmitting ions, and in particular, lithium ions participate in the electrochemical reaction of a battery. Suitable non-aqueous organic solvents include carbonate-based solvents, ester-based solvents, ether-based solvents, ketone-based solvents, alcohol-based solvents, aprotic solvents, and combinations thereof. Examples of carbonate-based solvents include but are not limited to dimethyl carbonate, diethyl carbonate, dipropyl carbonate, methylpropyl carbonate, ethylpropyl carbonate, methylethyl carbonate, ethylene carbonate, propylene carbonate, butylene carbonate, and combinations thereof. Examples of ester-based solvents include but are not limited to methyl acetate, ethyl acetate, n-propyl acetate, methylpropionate, ethylpropionate, γ-butyrolactone, decanolide, valerolactone, mevalonolactone, caprolactone, and combinations thereof. Examples of ether-based solvents include but are not limited to dibutyl ether, tetraglyme, diglyme, dimethoxyethane, 2-methyltetrahydrofuran, tetrahydrofuran, and the like, and the ketone-based solvent may include cyclohexanone, and the like. Examples of alcohol-based solvent include but are not limited to methanol, ethyl alcohol, n-propyl alcohol, isopropyl alcohol, and the like. Examples of the aprotic solvent include but are not limited to nitriles such as R—CN (where R is a C₂₋₂₀ linear, branched, or cyclic hydrocarbon that may include a double bond, an aromatic ring, or an ether bond), amides such as dimethylformamide, dioxolanes such as 1,3-dioxolane, sulfolanes, and the like. Advantageously, the non-aqueous organic solvent can be used singularly. In other variations, mixtures of the non-aqueous organic solvent can be used. Such mixtures are typically formulated to optimize battery performance. In a refinement, a carbonate-based solvent is prepared by mixing a cyclic carbonate and a linear carbonate. In a variation, electrolyte 30 can further include vinylene carbonate or an ethylene carbonate-based compound to improve battery cycle life.

Referring to FIGS. 2, 3, and 4, the negative electrode and the positive electrode can be fabricated by methods known to those skilled in the art of lithium-ion batteries. Typically, an active material (e.g., the positive or negative active material) is mixed with a conductive material, and a binder in a solvent (e.g., N-methylpyrrolidone) into an active material composition and coating the composition on a current collector. The electrode manufacturing method is well known and thus is not described in detail in the present specification. The solvent includes N-methylpyrrolidone and the like but is not limited thereto.

Referring to FIGS. 2, 3, and 4, the positive electrode active material layer 44 includes positive electrode active material, a binder, and a conductive material. The positive electrode active materials used herein can be those positive electrode materials known to one skilled in the art of lithium-ion batteries. In particular, the positive electrode 32 may be formed from a lithium-based active material that can sufficiently undergo lithium intercalation and deintercalation. The positive electrode 32 active materials may include one or more transition metals, such as manganese (Mn), nickel (Ni), cobalt (Co), chromium (Cr), iron (Fe), vanadium (V), and combinations thereof. Common classes of positive electrode active materials include lithium transition metal oxides with layered structure and lithium transition metal oxides with spinel phase. Examples of lithium transition metal oxides with layered structure include, but are not limited to lithium cobalt oxide (LiCoO2), lithium nickel oxide (LiNiO₂), a lithium nickel manganese cobalt oxide (e.g., Li(NiₓMn_{y}Co_{z})O₂), where 0≤x≤1, 0≤y≤1, 0≤z≤1, and x+y+z=1), a lithium nickel cobalt metal oxide (e.g., LiNi_{(1-x-y)}CoₓM_{y}O₂), where 0<x<1, 0<y<1 and M is Al, Mn). Other known lithium-transition metal compounds such as lithium iron phosphate (LiFePO₄) or lithium iron fluorophosphate (Li₂FePO₄F) can also be used. In certain aspects, the positive electrode 32 may include an electroactive material that includes manganese, such lithium manganese oxide (Li₍₁₊ₓ₎Mn₍₂₋ₓ₎O₄), a mixed lithium manganese nickel oxide (LiMn₍₂₋ₓ₎NiₓO₄), where 0≤x≤1, and/or a lithium manganese nickel cobalt oxide.

The binder for the positive electrode active material can improve the binding properties of positive electrode active material particles with one another and with the positive electrode current collector 42. Examples of suitable binders include but are not limited to polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylate styrene-butadiene rubber, an epoxy resin, nylon, and the like, and combinations thereof. The conductive material provides positive electrode 10 with electrical conductivity. Examples of suitable electrically conductive materials include but are not limited to natural graphite, artificial graphite, carbon black, acetylene black, ketjen black, carbon fibers, copper, metal powders, metal fibers, and combinations thereof. Examples of metal powders and metal fibers are composed of including nickel, aluminum, silver, and the like.

Referring to FIGS. 1, 2, and 3, the negative active material layer 26 includes a negative active material, includes a binder, and optionally a conductive material. The negative active materials used herein can be those negative materials known to one skilled in the art of lithium-ion batteries. Negative active materials include but are not limited to, carbon-based negative active materials, silicon-based negative active materials, and combinations thereof. A suitable carbon-based negative active material may include graphite and graphene. A suitable silicon-based negative active material may include at least one selected from silicon, silicon oxide, silicon oxide coated with conductive carbon on the surface, and silicon (Si) coated with conductive carbon on the surface. For example, silicon oxide can be described by the formula SiO_{z} where z is from 0.09 to 1.1. Mixtures of carbon-based negative active materials, silicon-based negative active materials can also be used for the negative active material.

The negative electrode binder improves the binding properties of negative active material particles with one another and with a current collector. The binder can be a non-aqueous binder, an aqueous binder, or a combination thereof. Examples of non-aqueous binder may be polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof. Aqueous binders can be rubber-based binders or polymer resin binders. Examples of rubber-based binders include but are not limited to styrene-butadiene rubbers, acrylated styrene-butadiene rubbers, acrylonitrile-butadiene rubbers, acrylic rubbers, butyl rubbers, fluorine rubbers, and combinations thereof. Examples of polymer resin binders include but are not limited to polyethylene, polypropylene, ethylenepropylene copolymer, polyethyleneoxide, polyvinylpyrrolidone, epichlorohydrin, polyphosphazene, polyacrylonitrile, polystyrene, ethylenepropylenediene copolymer, polyvinylpyridine, chlorosulfonated polyethylene, latex, a polyester resin, an acrylic resin, a phenolic resin, an epoxy resin, polyvinyl alcohol and combinations thereof.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A thermal runaway-inhibiting composition for a lithium-ion battery comprising a plurality of particles, each particle including:
an encapsulant configured to melt at a temperature greater than 70° C.; and
a flame retardant additive encapsulated by the encapsulant, the plurality of particles having a size distribution to inhibit thermal runaway when the thermal runaway-inhibiting composition is included in a battery cell.

2. The thermal runaway-inhibiting composition of claim 1, wherein the encapsulant has a melting point from about 70° C. to about 120° C.

3. The thermal runaway-inhibiting composition of claim 2, wherein the encapsulant is composed of a wax.

4. The thermal runaway-inhibiting composition of claim 2, wherein the encapsulant is composed of microcrystalline wax.

5. The thermal runaway-inhibiting composition of claim 1, wherein the plurality of particles have an average particle size from about 1 to 50 microns.

6. The thermal runaway-inhibiting composition of claim 1, wherein the flame retardant additive is selected from the group consisting of trimethyl phosphate (TMP), triphenyl phosphate (TPP), triallyl phosphates, and combinations thereof.

7. An electrode for a lithium-ion battery comprising;
a current collector;
an electrochemically active layer disposed over the current collector; and
a thermal runaway-inhibiting composition dispersed in and/or coating the electrochemically active layer, the thermal runaway-inhibiting composition includes a plurality of particles, each particle including:
an encapsulant configured to melt at a temperature greater than 70° C.; and
a flame retardant additive encapsulated by the encapsulant, the flame retardant additive being present in a sufficient amount to inhibit thermal runaway in a battery when the thermal runaway-inhibiting composition is included therein.

8. The electrode of claim 7, wherein the electrode is a positive electrode and the electrochemically active layer is a positive electrode active layer.

9. The electrode of claim 7, wherein the encapsulant has a melting point from about 70° C. to about 120° C.

10. The electrode of claim 7, wherein the encapsulant is composed of a wax.

11. The electrode of claim 7, the encapsulant is composed of microcrystalline wax.

12. The electrode of claim 7, wherein the plurality of particles have an average particle size from about 1 to 50 microns.

13. The electrode of claim 7, wherein the flame retardant additive is selected from the group consisting of trimethyl phosphate (TMP), triphenyl phosphate (TPP), triallyl phosphates, and combinations thereof.

14. A rechargeable lithium-ion battery comprising at least one lithium-ion battery cell, each lithium-ion battery cell including:
a positive electrode;
a negative electrode including a negative active material;
an electrolyte; and
a thermal runaway-inhibiting composition comprising a plurality of particles, each particle including:
an encapsulant configured to melt at a temperature greater than 70° C.; and
a flame retardant additive encapsulated by the encapsulant, the flame retardant additive being present in a sufficient

15. The rechargeable lithium-ion battery of claim 14, wherein the at least one lithium-ion battery cell is a plurality of battery cells.

16. The rechargeable lithium-ion battery of claim 14, wherein each battery cell further includes a separator interposed between the positive electrode and the negative electrode.

17. The rechargeable lithium-ion battery of claim 14, wherein the encapsulant has a melting point from about 70° C. to about 120° C.

18. The rechargeable lithium-ion battery of claim 14, wherein the encapsulant is composed of microcrystalline wax.

19. The rechargeable lithium-ion battery of claim 14, wherein the plurality of particles have an average particle size from about 1 to 50 microns.

20. The rechargeable lithium-ion battery of claim 14, wherein the flame retardant additive is selected from the group consisting of trimethyl phosphate (TMP), triphenyl phosphate (TPP), triallyl phosphates, and combinations thereof.
